(19) United States
(12) Patent Application Publication
(10) Pub. No.: US 2021/0096209 A1
(43) Pub. Date: Apr. 1, 2021

(54) RADAR-ENABLED MULTI-VEHICLE SYSTEM

(71) Applicant: Rogers Corporation, Chandler, AZ (US)

(72) Inventors: Robert C. Daigle, Paradise Valley, AZ (US); Shawn P. Williams, Andover, MA (US); Mark Brandstein, Auburndale, MA (US)

(21) Appl. No.: 17/028,079

(22) Filed: Sep. 22, 2020

Related U.S. Application Data
(60) Provisional application No. 62/906,206, filed on Sep. 26, 2019.

(51) Int. Cl. G01S 7/00; B64C 39/02; B64C 1/36; G01S 13/935

(52) U.S. Cl. CPC G01S 7/006; B64C 39/024; B64C 2201/12; G01S 13/935; B64C 2201/027; B64C 1/36

(57) ABSTRACT

A radar-enabled multi-vehicle system includes: at least two vehicles, each vehicle having: at least one antenna; a radar module configured and disposed to be in signal communication with the at least one antenna, the radar module configured to transmit and receive radar signals from and to the at least one antenna; a connectivity module configured and disposed to be in signal communication with the radar module, and to be in signal communication with a corresponding connectivity module of another one of the at least two vehicles; and, a power source configured and disposed to provide operational power to the at least one antenna, the radar module, and the connectivity module.

### CROSS REFERENCE TO RELATED APPLICATIONS

This application claims the benefit of U.S. Provisional Application Ser. No. 62/906,206, filed Sep. 26, 2019, which is incorporated herein by reference in its entirety.

### BACKGROUND OF THE INVENTION

The present disclosure relates generally to a radar-enabled multi-vehicle system, particularly to a radar-enabled multi-vehicle system comprising an unmanned autonomous vehicle, and more particularly to a radar-enabled multi-vehicle system comprising an unmanned autonomous flying vehicle.

Some current surveillance systems utilize drones (unmanned autonomous flying vehicles, UAFVs) for performing monitoring and threat surveillance of a geographic region. An onboard camera provides visual information relating the location, path of travel, and surroundings, of the UAFV that is relayed to an operator of a remote control for controlling the UAFV and commanding the UAFV to perform specific monitoring and threat surveillance tasks. Use of and reliance on an optical camera for providing the visual information upon which control decisions are made by the operator can substantially limit the utility of such UAFVs, which may only be useful in daytime and good weather conditions. Other factors that may limit the utility of such UAFV surveillance systems may include: low resolution imagery of the onboard camera; missing speed and/or direction data of the UAFV; and, use of costly specialized payloads to enhance the utility of the UAFV, but which reduce the time of use and/or flight of the UAFV due to the extra payload weight.

Accordingly, and while existing UAFV surveillance systems may be useful for their intended purpose, the art relating to unmanned autonomous vehicle, UAV, and particularly UAFV, monitoring and threat surveillance systems would be advanced with a system that overcomes the above noted deficiencies.

### BRIEF DESCRIPTION OF THE INVENTION

An embodiment includes a radar-enabled multi-vehicle system, comprising: at least two vehicles, each vehicle comprising: at least one antenna; a radar module configured and disposed to be in signal communication with the at least one antenna, the radar module configured to transmit and receive radar signals from and to the at least one antenna; a connectivity module configured and disposed to be in signal communication with the radar module, and to be in signal communication with a corresponding connectivity module of another one of the at least two vehicles; and, a power source configured and disposed to provide operational power to the at least one antenna, the radar module, and the connectivity module.

Another embodiment includes the above noted radar-enabled multi-vehicle system wherein each vehicle of the at least two vehicles further comprises: a fleet management processing unit configured and disposed in signal communication with the connectivity module of a corresponding given vehicle, the fleet management processing unit configured and disposed for executing machine executable instructions which when executed by the fleet management processing unit facilitates coordinated operational control of the corresponding given vehicle, and provides coordinated operational control information to each neighboring vehicle within a defined neighborhood of the given vehicle via a corresponding connectivity module.

Another embodiment includes a radar-enabled multi-vehicle system, comprising: at least one unmanned autonomous flying vehicle, UAFV, comprising: at least one antenna; a radar module configured and disposed to be in signal communication with the at least one antenna, the radar module configured to transmit and receive radar signals from and to the at least one antenna; a connectivity module configured and disposed to be in signal communication with the radar module, and to be in signal communication with a corresponding connectivity module of another one of the at least one UAFV; and, a power source configured and disposed to provide operational power to the at least one antenna, the radar module, and the connectivity module.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts an illustration of an example radar-enabled multi-vehicle system having at least one vehicle, in accordance with an embodiment;

FIG. 2 depicts an illustration of an example of the at least one vehicle of FIG. 1, in accordance with an embodiment;

FIG. 3 depicts an illustration of an example arrangement for performing signal processing and image reconstruction using the at least one vehicle of FIGS. 1 and 2, in accordance with an embodiment;

FIG. 4 depicts an illustration of another example arrangement for performing signal processing and image reconstruction using the at least one vehicle of FIGS. 1 and 2, in accordance with an embodiment;

FIG. 5A depicts an illustration of an example arrangement for charging or recharging a power source of a corresponding one of the at least one vehicle of FIGS. 1 and 2, in accordance with an embodiment;

FIG. 5B depicts an illustration of another example arrangement for charging or recharging a power source of a corresponding one of the at least one vehicle of FIGS. 1 and 2, in accordance with an embodiment;

FIG. 6 depicts a rotated isometric transparent view of example structures, such as an electromagnetic apparatus, an antenna, and a dielectric resonator antenna, for use in accordance with an embodiment of the at least one vehicle of FIGS. 1 and 2, in accordance with an embodiment;

FIGS. 7A-7K depict rotated isometric views of alternative three-dimensional, 3D, dielectric structures for use in accordance with an embodiment of the electromagnetic apparatus, antenna, and/or dielectric resonator antenna, of FIG. 6, in accordance with an embodiment;

FIGS. 8A-8E depict in plan view alternative two-dimensional cross sectional shapes of the 3D dielectric structures of FIGS. 7A-7K, in accordance with an embodiment;

FIG. 9 depicts an illustration of an example of a swarm fleet of the at least one vehicle of FIGS. 1 and 2 in the form of drones, in accordance with an embodiment; and

FIGS. 10A-10I depict illustrations of alternative generic forms of the at least one vehicle of FIGS. 1 and 2, in accordance with an embodiment.

### DETAILED DESCRIPTION OF THE INVENTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. Accordingly, the following example embodiments are set forth without any loss of generality to, and without imposing limitations upon, the claimed invention disclosed herein.

An embodiment, as shown and described by the various figures and accompanying text, provides a drone swarm management system that utilizes an innovative radar module antenna design combined with a drone swarm management system for automating a multi-drone launch, flight, surveillance, and/or recharge operation.

Another embodiment, as further shown and described by the various figures and accompanying text, provides a radar-enabled multi-vehicle system where: one vehicle may be configured to communicate with another vehicle for autonomous or semi-autonomous control of one or both of the vehicles; one vehicle may be configured to communicate with a base station for autonomous or semi-autonomous control of the vehicle; or, a plurality of vehicles may be configured to communicate with each other vehicle of the plurality and/or a base station for autonomous or semi-autonomous control of each of the vehicles.

While embodiments described herein may refer to an UAFV (drone, for example) as an example vehicle suitable for a purpose disclosed herein, it will be appreciated that the disclosed invention may also be applicable to vehicles or transport apparatus other than drones, which will be discussed and described further herein below. In an embodiment, each vehicle of the radar-enabled multi-vehicle system may comprise a dielectric resonator antenna, DRA, that is configured to operate at radar frequencies for canvassing a region of interest during a monitoring and threat surveillance operation.

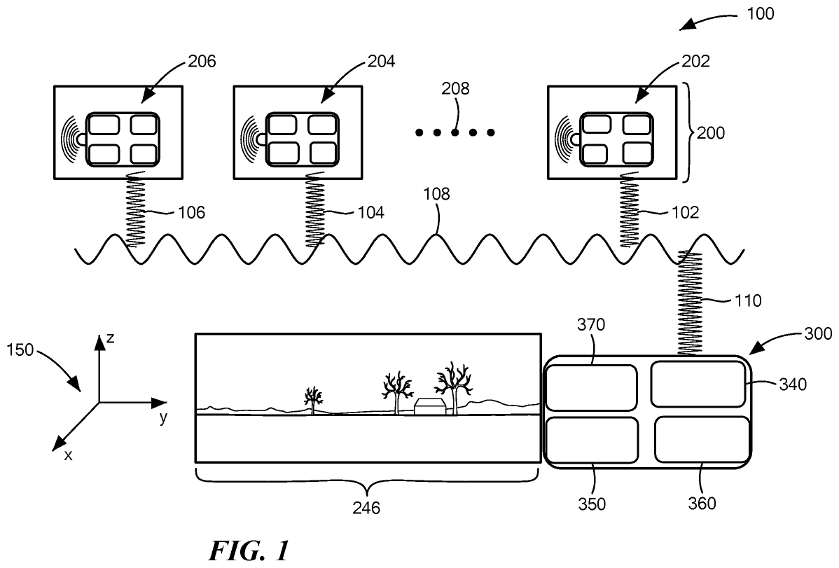

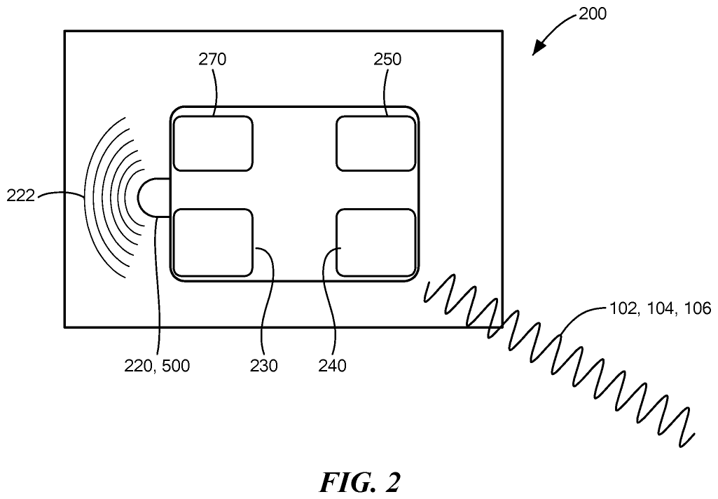

Reference is now made primarily to FIGS. 1 and 2 in combination.

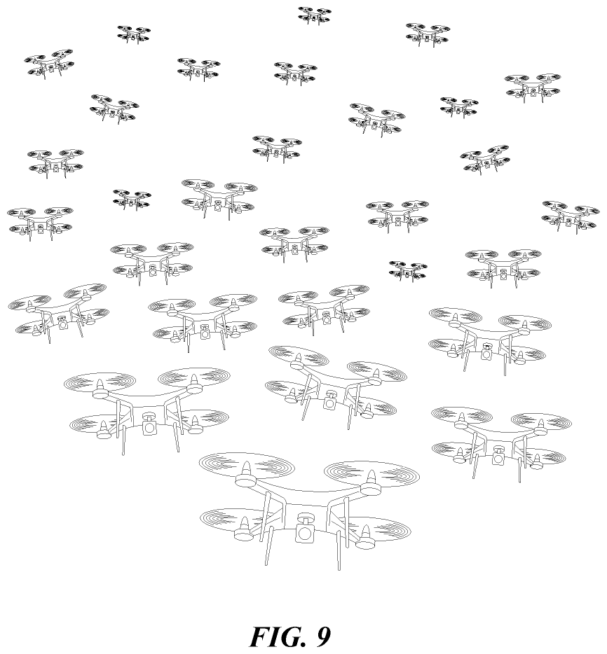

FIG. 1 depicts an example embodiment of a radar-enabled multi-vehicle system 100 having at least two vehicles 200, depicted individually as vehicles 202, 204, and 206. Ellipses 208 represent the optional existence of a multitude of other vehicles 200 that as a group form a swarm of vehicles 200 (a swarm fleet). FIG. 9 depicts an example of a swarm fleet of vehicles 200 in the form of drones. The system 100 may also include a communication base station 300, which may be in or on a stationary unit such as but not limited to a building, or which may be in or on a mobile unit such as but not limited to a vehicle that is operational on land (such as a truck for example), water (such as a ship for example), or both land and water. In an embodiment: one vehicle 202, 204, 206 may be configured to communicate with another vehicle 202, 204, 206 for autonomous or semi-autonomous control of one or both of the vehicles 202, 204, 206, via signals 102, 104, 106, 108; one vehicle 202 may be configured to communicate with the base station 300 for autonomous or semi-autonomous control of the vehicle 202, via signals 102, 108, 110; or, a plurality of vehicles 200 may be configured to communicate with each other vehicle 202, 204, 206 of the plurality of vehicles 200 and/or the base station 300 for autonomous or semi-autonomous control of each of the vehicles 202, 204, 206, via signals 102, 104, 106, 108, 110.

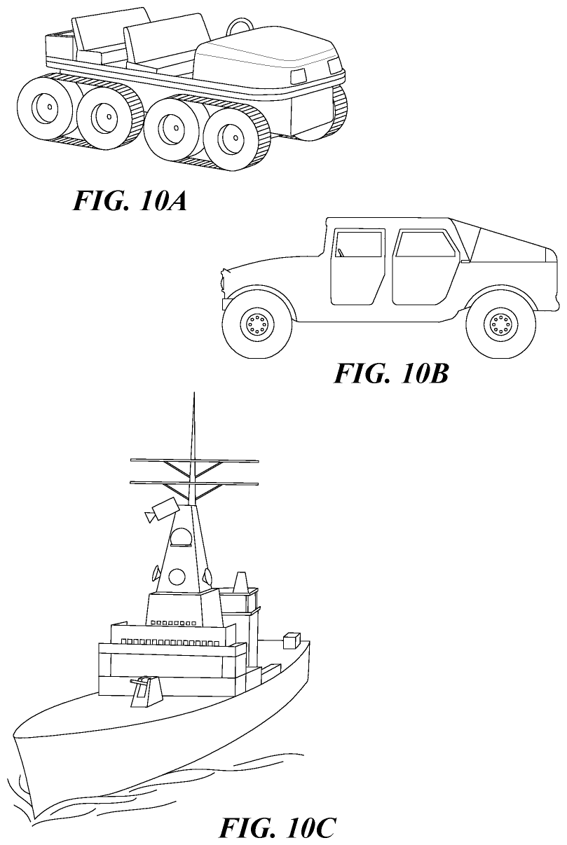

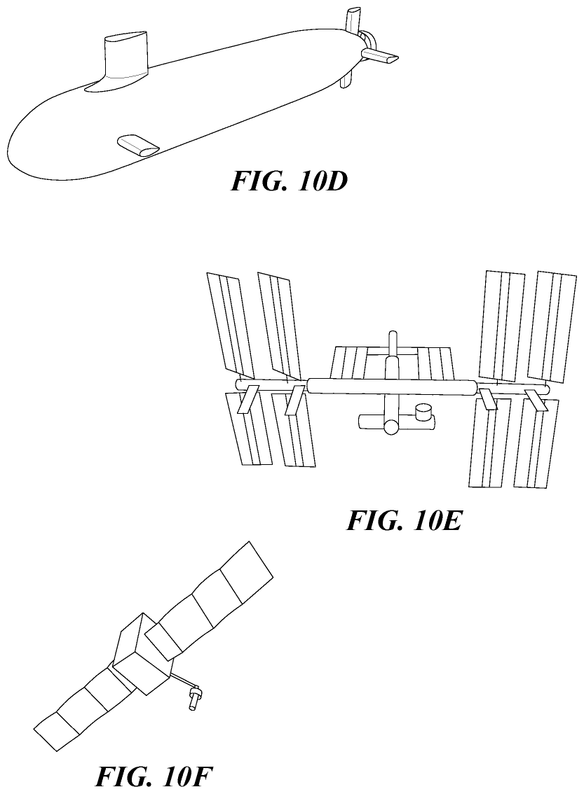

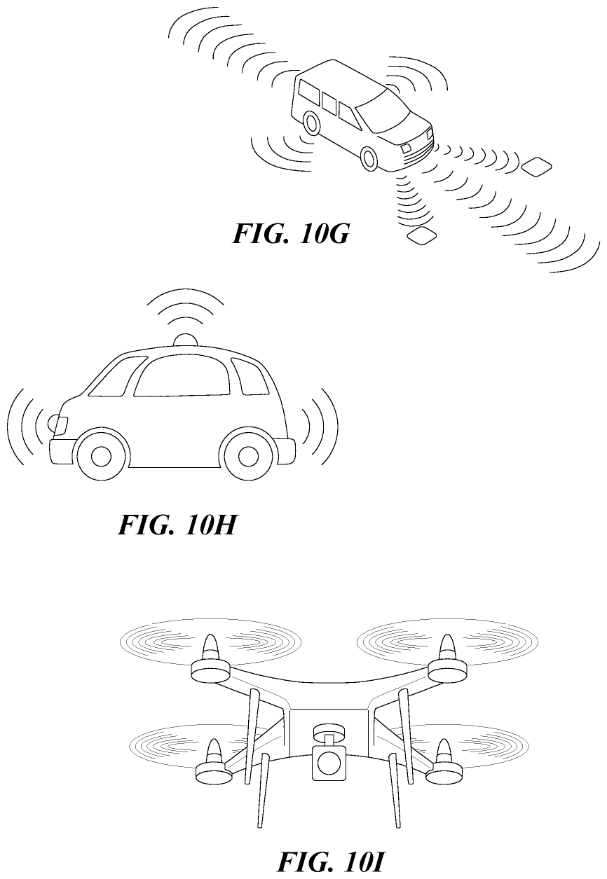

In an embodiment, the aforementioned at least two vehicles 200 may be at least one vehicle 200, which may be an UAFV 200, such as a drone for example. However, the scope of an invention disclosed herein is not limited to an UAFV, but also encompasses other vehicles or transport apparatus, such as but not limited to: any form of a terrestrial vehicle, such as an all-terrain vehicle for example (see FIG. 10A for example); any form of an automotive vehicle, such as a truck for example (see FIG. 10B for example); any form of a marine vehicle, such as a ship for example (see FIG. 10C for example); any form of a sub-marine vehicle, such as a submarine for example (see FIG. 10D for example); any form of a non-terrestrial vehicle, such as a space station for example (see FIG. 10E for example); any form of a satellite, such as a geosynchronous satellite for example (see FIG. 10F for example); any form of an autonomous vehicle, such as a self-driving car for example (see FIG. 10G for example); any form of an unmanned autonomous vehicle, such as a radio controlled vehicle for example (see FIG. 10H for example); or, any form of an unmanned autonomous flying vehicle, such as a drone for example (see FIG. 10I for example).

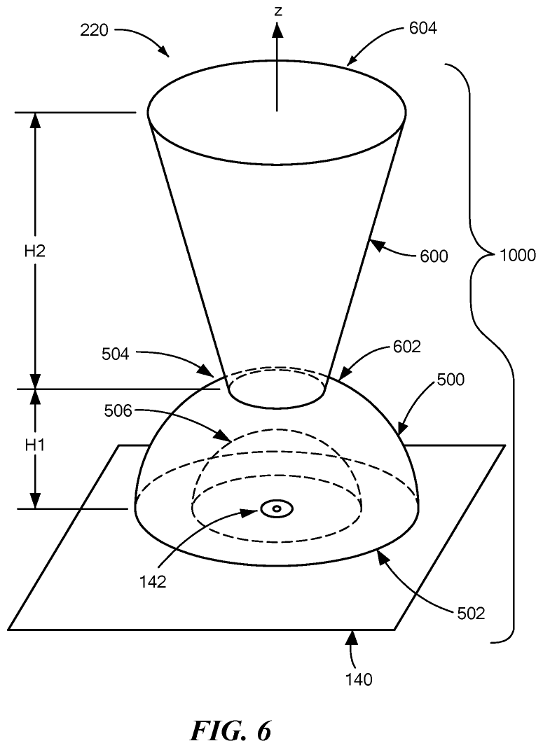

FIG. 2 depicts an example embodiment of a vehicle 200 (any one of vehicles 202, 204, 206, 208) having: at least one antenna 220, which may be configured as a transmitter antenna, a receiver antenna, or both a transmitter and a receiver antenna; a radar module 230 configured and disposed to be in signal communication with the at least one antenna 220, the radar module 230 configured to transmit and receive radar signals 222 from and to the at least one antenna 220; a connectivity module 240 configured and disposed to be in signal communication with the radar module 230, and to be in signal communication with a corresponding connectivity module 240 of another one of the at least two vehicles 200 (see FIG. 1 for example) via signals 102, 104, 106 when present; and a power source 250 configured and disposed to provide operational power to the at least one antenna 220, the radar module 230, and the connectivity module 240. In an embodiment, the at least one antenna 220 comprises a dielectric resonator antenna, DRA 500 (reference numeral 220 is applied herein in reference to an antenna generally, and reference numeral 500 is applied herein in reference to an antenna 220 that is a DRA specifically—see FIG. 6 for illustration of an example DRA 500). In an embodiment, the antenna 220 and radar module 230 are operational in the millimeter-wave radar spectrum, such as but not limited to 60-81 GHz. Example DRAs 500 for the antenna 220 are described further herein below with reference to FIG. 6. In an embodiment, the radar module 230 is operational beyond a visual line of sight with respect to a corresponding vehicle 200 on which the radar module 230 is disposed. In an embodiment, the power source 250 may be any power source suitable for a purpose disclosed herein, such as but not limited to: a battery; a fossil fuel engine or fossil fuel powered power source; a solar cell or solar powered power source; a fuel cell or fuel cell powered power source; or, any combination of the foregoing power sources. In an embodiment, each vehicle 200 may also include a fleet management processing unit 270 powered by the power source 250 and configured and disposed in signal communication with the connectivity module 240 of a corresponding given vehicle 200, the fleet management processing unit 270 configured and disposed for executing machine executable instructions which when executed by the fleet management processing unit 270 facilitates coordinated operational control of the corresponding given vehicle 200, and provides coordinated operational control information to each neighboring vehicle 200 within a defined neighborhood of the given vehicle 200 via a corresponding connectivity module 240. In an embodiment, the defined neighborhood with respect to a given vehicle 200 may be fixed, adjustable, or operator specified, and may range from a few centimeters to a few meters in a spherical radius, or to tens of meters or more, in a spherical radius. As used herein, the term operator refers to one or more specific persons who are or may be in control of the swarm fleet of vehicles.

With reference back to FIG. 1, an example embodiment of the base station 300 includes: a base connectivity module 340 configured and disposed to be in signal communication with a corresponding connectivity module 240 of each of the at least two vehicles 200, the base connectivity module 340 configured and disposed for receiving communication signals from the at least two vehicles 200 via signals 102, 104, 106, 108, 110, the communication signals including information based at least in part on corresponding received radar signals (see radar signal 222 in FIG. 2 for example); and a base signal processing unit 360 configured and disposed to be in signal communication with the base connectivity module 340, the base signal processing unit 360 configured and disposed for executing machine executable instructions which when executed by the base signal processing unit 360 facilitates signal processing and image reconstruction based at least in part on the received communication signals from the at least two vehicles 200. In an embodiment, the base station 300 also includes a base fleet management processing unit 370 configured and disposed in signal communication with the base connectivity module 340, the base fleet management processing unit 370 configured and disposed for executing machine executable instructions which when executed by the base fleet management processing unit 370 facilitates coordinated operational control of each of the at least two vehicles 200 via the base connectivity module 340 and corresponding connectivity modules 240 of the at least two vehicles 200. In an embodiment, the base fleet management processing unit 370 is further configured to cooperatively operate with each fleet management processing unit 270 of a corresponding vehicle 200. Operational power to any component of the base station 300, such as but not limited to the base connectivity module 340, the base signal processing unit 360, and the base fleet management processing unit 370, is provided by a power source 350 integrally arranged within the base station 300. In an embodiment, the power source 350 may be any power source suitable for a purpose disclosed herein, such as but not limited to: a battery; a fossil fuel engine or fossil fuel powered power source; a solar cell or solar powered power source; a fuel cell or fuel cell powered power source; or, any combination of the foregoing power sources. In an embodiment, the base connectivity module 340 is configured to receive signal communications from a corresponding connectivity module 240 of each of the at least two vehicles 200, to transmit signal communications to a corresponding connectivity module 240 of each of the at least two vehicles 200, or to both receive and transmit signal communications from and to a corresponding connectivity module 240 of each of the at least two vehicles 200.

In an embodiment, the at least two vehicles 200 are operational and movable with respect to a first reference frame or coordinate system 150 (see orthogonal x-y-z coordinate system in FIG. 1 for example), and the base station 300 is operational and stationary with respect to the first reference frame or coordinate system 150. For example, the base station 300 may be housed in a stationary building or in a stationary truck (stationary relative to a stationary point on earth), while the vehicles 200 are operational and movable with respect to the building or truck. In another embodiment, the at least two vehicles 200 are operational and movable with respect to the first reference frame or coordinate system 150, and the base station 300 is operational and movable with respect to the first reference frame or coordinate system 150. For example, the base station 300 may be housed on a moving ship or moving truck (moving relative to a stationary point on earth), while the vehicles 200 are operational and movable with respect to the moving ship or moving truck (here, the vehicles may be movable or stationary relative to a stationary point of earth).

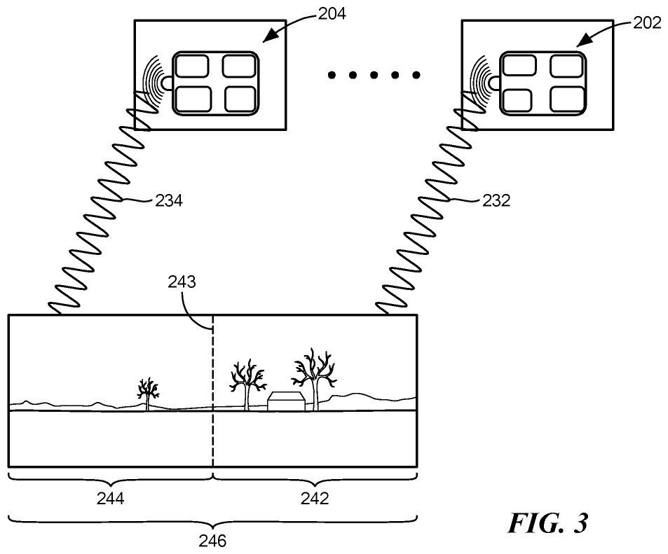

Reference is now made to FIG. 3 in combination with FIGS. 1 and 2. In an embodiment, the signal processing and image reconstruction executed by the base signal processing unit 360 is based at least in part on an aggregate of radar data from received radar signals 232, 234 from corresponding multiple ones (vehicles 202, 204 for example) of the at least two vehicles 200, the aggregate radar data creating a virtual synthetic radar antenna aperture that is communicated to the base station 300 from each of the at least two vehicles 200, the signal processing and image reconstruction executed by the base signal processing unit 360 providing a single consolidated image 246 from individual images 242, 244 received from corresponding vehicles 202, 204. Stated alternatively, radar data received from radar signals 232, 234 from corresponding vehicles 202, 204 is communicated to the base station 300 via signal communication between connectivity modules 240 of corresponding vehicles 202, 204, and the base connectivity module 340 of the base station 300. The radar data from corresponding radar signals 232, 234 is representative of the corresponding individual images 242, 244, which are processed via the base signal processing unit 360 to produce the single consolidated image 246. The providing of aggregate radar data to provide the single consolidated image is herein referred to as creating a virtual synthetic radar antenna aperture. While FIG. 3 depicts an arrangement for creating a virtual synthetic radar antenna aperture using just two vehicles 202, 204 and two images 242, 244, it will be appreciated that this is for illustration purposes only, and that the scope of the invention disclosed herein extends to the creation of a virtual synthetic radar antenna aperture using multiples of vehicles 200 and corresponding multiples of images 242, 244, 243 (where dashed line 243 represents one or more additional images) using appropriate signal processing and image reconstruction software and techniques.

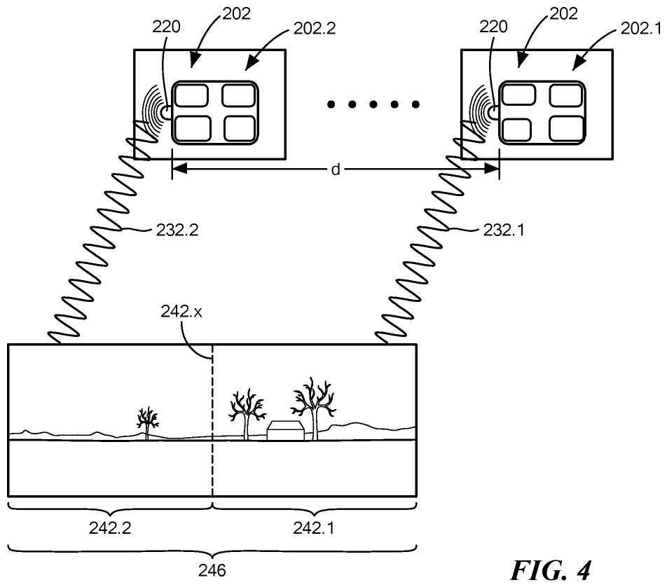

Reference is now made to FIG. 4 in combination with FIGS. 1 and 2. While FIG. 3 depicted an arrangement for creating a virtual synthetic radar antenna aperture using two, or more, vehicles 200, it will be appreciated that a virtual synthetic radar antenna aperture may also be created by using a single vehicle, 202 for example, that records imagery while in motion. Accordingly, an embodiment includes signal processing and image reconstruction executed by the base signal processing unit 360 that is based at least in part on an aggregate of radar data from received radar signals 232.1, 232.2 from a single one vehicle 202 of the at least two vehicles 200 that is in motion from position 202.1 to position 202.2, the aggregate radar data creating a synthetic radar antenna aperture that is communicated to the base station 300 from the single one vehicle 202 of the at least two vehicles 200 that is in motion, the distance d the corresponding single vehicle 202 travels over a target, scene 246 for example, in the time taken for the radar pulses to return to the corresponding at least one antenna 220 creates the synthetic radar antenna aperture, the signal processing and image reconstruction executed by the base station 300 providing a single consolidated image 246 from individual images 242.1, 242.2 received from the single vehicle 202 while in motion from position 202.1 to position 202.2. While FIG. 4 depicts an arrangement for creating a virtual synthetic radar antenna aperture using a single vehicle 202 and just two individual images 242.1, 242.2, it will be appreciated that this is for illustration purposes only, and that the scope of the invention disclosed herein extends to the creation of a virtual synthetic radar antenna aperture using multiples of images 242.1, 242.2, 242.x (where dashed line 242.x represents one or more additional images) from a corresponding single vehicle 200 using appropriate signal processing and image reconstruction software and techniques.

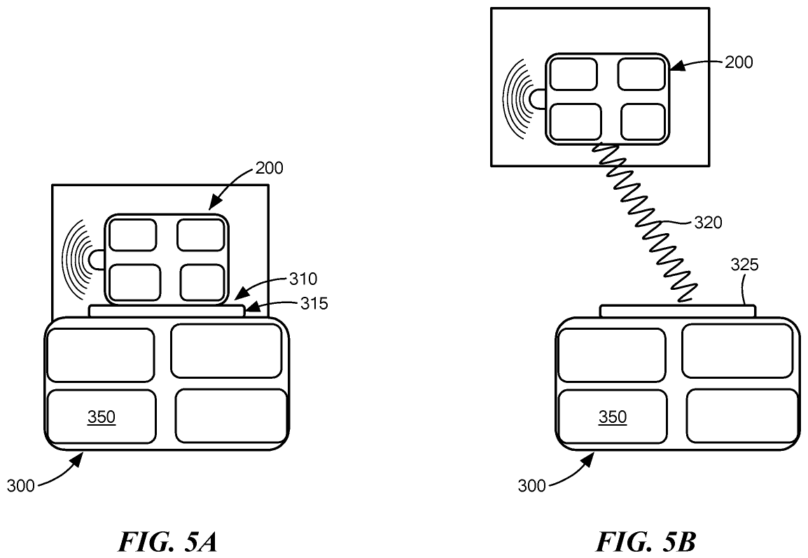

Reference is now made to FIGS. 5A and 5B, which depict alternative arrangements for charging or recharging the power source 250 of a corresponding vehicle 200. With respect to FIG. 5A, an embodiment includes a charging/recharging arrangement where the power source 250 of a corresponding vehicle 200 is chargeable and/or rechargeable via an inductive charge coupling 310 to a remote charging station 315 that may be configured to receive power from power source 350, or from any other power source suitable for a purpose disclosed herein. In an embodiment, the remote charging station 310 is mounted to or is connectable via an exterior surface of the base station 300, which as noted herein above may be part of a stationary unit or a mobile unit. With respect to FIG. 5B, an embodiment includes a charging/recharging arrangement where the power source 250 of a corresponding vehicle 200 is chargeable and/or rechargeable via an electrical tether connection 320 to a remote base power unit 325 that may be configured to receive power from power source 350, or from any other power source suitable for a purpose disclosed herein, the tether connection 320 being disconnectable from the remote base power unit 325 on demand. In an embodiment, the tether connection 320 is disconnectable from the remote base power unit 325 in response to the power source 250 being fully recharged, in response to a signal from the fleet management processing unit 270 of a corresponding vehicle 200 that a disconnect operation is warranted (e.g., a surveillance threat notification has been identified requiring attention regardless of the charge status), or in response to a signal from the base fleet management processing unit 370 of the base station 300 that a disconnect operation is warranted (e.g., a surveillance threat notification has been identified requiring attention regardless of the charge status).

In an embodiment, the aforementioned coordinated operational control of each or any of the vehicles 200 that is facilitated and executed by the fleet management processing unit 270, or the base fleet management processing unit 370, includes but is not limited to: vehicle collision avoidance control between any of the at least two vehicles 200 within the defined neighborhood; beyond visual line of sight control with respect to each of the at least two vehicles 200; suspect object or threat identification control with respect to each of the at least two vehicles 200; includes surveillance area control with respect to each of the at least two vehicles 200; power monitoring control with respect to each of the at least two vehicles 200; coordinated movement control with respect to each of the at least two vehicles 200; and/or, coordinated vehicle densification or replace control with respect to each of the at least two vehicles 200. In an embodiment, the fleet management processing unit 270, the base fleet management processing unit 370, or both units 270 and 370, further include executable instructions which when executed by the respective unit 270, 370 facilitates sharing of radar data from each vehicle 200 with any other vehicle 200 and/or with the base station 300.

Reference is now made to FIG. 6, which depicts an example antenna 220 and DRA 500 contemplated to be suitable for a purpose disclosed herein. In an embodiment, the at least one antenna 220 comprises at least one DRA 500 that may or may not include a dielectric lens or waveguide 600 configured and disposed in electromagnetic, EM, communication with the DRA 500. In an embodiment, the dielectric lens 600 is a Luneburg lens having a dielectric material with a dielectric constant that varies from one portion of the dielectric lens 600 to another portion of the dielectric lens 600, and in an embodiment more specifically varies decreasingly from an inner portion of the dielectric lens 600 to an outer surface of the dielectric lens 600, and in another embodiment even more specifically varies decreasingly from a center region of the dielectric lens 600 to an outer surface of the dielectric lens 600. That said, in another embodiment the dielectric lens 600 is not a Luneburg lens per se, but may still be a lens formed of a dielectric material composed of different dielectric constants. In an embodiment, the DRA 500 may alternatively be referred to as a first dielectric portion, 1DP, and the lens or waveguide 600 may alternatively be referred to as a second dielectric portion, 2DP. In an embodiment, the 1DP 500 has a proximal end 502 and a distal end 504, and the 2DP 600 has a proximal end 602 and a distal end 604, where the proximal end 602 of the 2DP 600 is disposed proximate and in EM communication with the distal end 504 of the 1DP 500. In an embodiment, the proximal end 602 of the 2DP 600 is disposed in direct contact with the distal end 504 of the 1DP 500. In an embodiment, the 1DP 500 is disposed on an electrically conductive ground structure 140 (the “ground” being in reference to an electrical ground reference potential of the vehicle 200). In an embodiment, the at least one antenna 220 includes a plurality of antennas 220 arranged in an array, and more specifically includes an array of DRAs 500. In an embodiment, each DRA 500 of the array of DRAs 500 are arranged and disposed on a common electrically conductive ground structure 140.

In an embodiment, the 1DP 500 may be a plurality of volumes of dielectric materials disposed on the ground structure 140, wherein the plurality of volumes of dielectric materials comprise N volumes, N being an integer equal to or greater than 3, disposed to form successive and sequential layered volumes V(i), i being an integer from 1 to N, wherein volume V(1) forms an innermost volume, wherein a successive volume V(i+1) forms a layered shell disposed over and at least partially embedding volume V(i), wherein volume V(N) at least partially embeds all volumes V(1) to V(N−1). The dashed line form 506 depicted in FIG. 6 is representative of any number of the plurality of volumes of dielectric materials V(N) as disclosed herein. In an embodiment, an electrical signal feed 142 is disposed and structured to be electromagnetically coupled to one or more of the plurality of volumes of dielectric materials. While FIG. 6 depicts the electrical signal feed 142 as being representative of a coaxial cable, it will be appreciated that this is for illustration purposes only, and that the signal feed 142 may be any kind of signal feed suitable for a purpose disclosed herein, such as a copper wire, a coaxial cable, a microstrip (e.g., with slotted aperture), a stripline (e.g., with slotted aperture), a waveguide, a surface integrated waveguide, a substrate integrated waveguide, or a conductive ink, for example, that is electromagnetically coupled to the respective 1DP 500. Furthermore, while FIG. 6 depicts the signal feed 142 being disposed in EM signal communication with the innermost volume V(1), it will be appreciated that this is for illustration purposes only, and that the signal feed 142 may be disposed in EM signal communication with any volume V(N) consistent with a purpose disclosed herein, such as but not limited to volume V(2) for example.

In an embodiment, volume V(1) comprises air. In an embodiment, volume V(2) comprises a dielectric material other than air. In an embodiment, volume V(N) comprises air. In an embodiment, volume V(N) comprises a dielectric material other than air. As would be understood by use of the term “comprises”, a volume V(i) that comprises air does not negate the presence of a dielectric material other than air, such as a dielectric foam that comprises air within the foam structure.

As disclosed herein and with reference to all of the foregoing, an EM apparatus 1000 (with reference to FIG. 6) may comprise a 1DP 500 in the form of a dielectric resonator antenna, DRA, for example, and a 2DP 600 in the form of: a dielectric lens, or any other dielectric element that forms an EM far field beam shaper, for example; or, a dielectric waveguide, or any other dielectric element that forms an EM near field radiation conduit, for example. As disclosed herein, and as will be appreciated by one skilled in the art, the 1DP and the 2DP are distinguishable over each other in that the 1DP is structurally configured and adapted to have an EM resonant mode that coincides with an EM frequency of an electrical signal source that is electromagnetically coupled to the 1DP, and the 2DP is structurally configured and adapted to: in the case of a dielectric EM far field beam shaper, serve to affect the EM far field radiation pattern originating from the 1DP when excited without itself having a resonant mode that matches the EM frequency of the electrical signal source; or, in the case of a dielectric EM near field radiation conduit, serve to propagate the EM near field emission originating from the 1DP when excited with little or no EM signal loss along the length of the 2DP.

As used herein, the phrase electromagnetically coupled is a term of art that refers to an intentional transfer of EM energy from one location to another without necessarily involving physical contact between the two locations, and in reference to an embodiment disclosed herein more particularly refers to an interaction between an electrical signal source having an EM frequency that coincides with an EM resonant mode of the associated 1DP and/or 1DP combined with the 2DP. In an embodiment, the electromagnetically coupled arrangement is selected such that greater than 50% of the resonant mode EM energy in the near field is present within the 1DP for a selected operating free space wavelength associated with the EM apparatus.

In some embodiments disclosed herein, the height H2 of the 2DP is greater than the height H1 of the 1DP (e.g., the height of the 2DP is greater than 1.5 times the height of the 1DP, or the height of the 2DP is greater than 2 times the height of the 1DP, or the height of the 2DP is greater than 3 times the height of the 1DP). In some embodiments, the average dielectric constant of the 2DP is less than the average dielectric constant of the 1DP (e.g., the average dielectric constant of the 2DP is less than 0.5 the average dielectric constant of the 1DP, or the average dielectric constant of the 2DP is less than 0.4 the average dielectric constant of the 1DP, or the average dielectric constant of the 2DP is less than 0.3 the average dielectric constant of the 1DP). In some embodiments, the 2DP has axial symmetry around a specified axis. In some embodiments, the 2DP has axial symmetry around an axis that is normal to an electrical ground plane surface on which the 1DP is disposed.

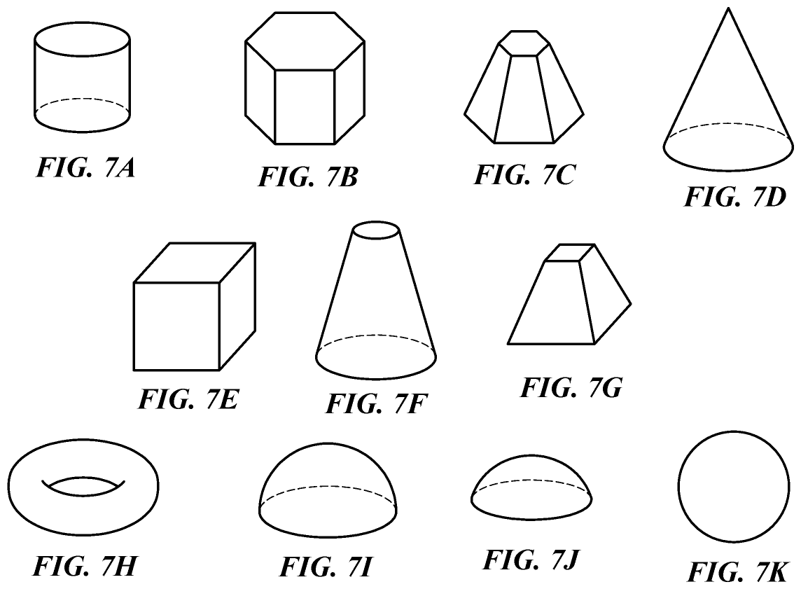

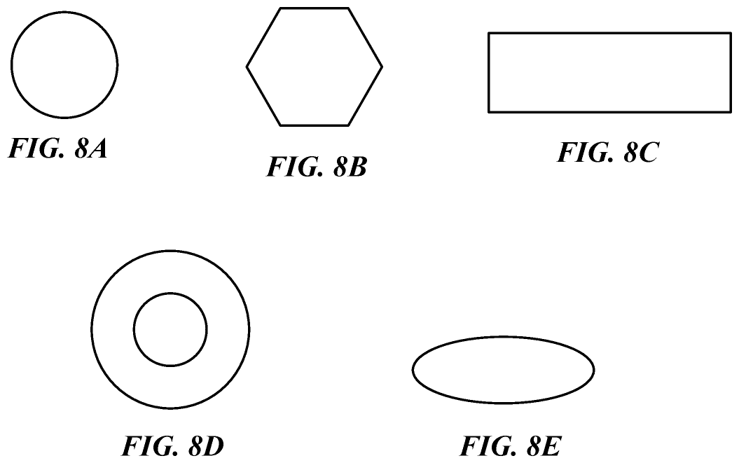

In an embodiment, and with reference to FIGS. 7A-7K, any dielectric structure 500, 600 disclosed herein may have a three-dimensional form in the shape of a cylinder (FIG. 7A), a polygon box (FIG. 7B) a tapered polygon box (FIG. 7C), a cone (FIG. 7D), a cube (FIG. 7E), a truncated cone (FIG. 7F), a square pyramid (FIG. 7G), a toroid (FIG. 7H), a dome (FIG. 7I), an elongated dome (FIG. 7J), a sphere (FIG. 7K), or any other three-dimensional form suitable for a purpose disclosed herein. Referring now to FIGS. 8A-8E, such shapes can have can have a z-axis cross section in the shape of a circle FIG. 8A), a polygon (FIG. 8B), a rectangle (FIG. 8C), a ring (FIG. 8D), an ellipsoid (FIG. 8E), or any other shape suitable for a purpose disclosed herein. In addition, the shape can depend on the polymer used, the desired dielectric gradient, and the desired mechanical and electrical properties.

With particular but not limited reference to the above described radar module 230, connectivity module 240, fleet management processing unit 270, base connectivity module 340, base signal processing unit 360, and base fleet management processing unit 370, an embodiment as disclosed herein may be embodied in the form of computer-implemented processes and apparatuses for practicing those processes. In an embodiment, an apparatus for practicing those processes may be a control or signal processing module, which may be a processor-implemented module or a module implemented by a computer processor, and may include a microprocessor, an ASIC, or software on a microprocessor. An embodiment as disclosed herein may also be embodied in the form of a computer program product having computer program code containing instructions embodied in a non-transitory tangible media, such as floppy diskettes, CD-ROMs, hard drives, USB (universal serial bus) drives, or any other computer readable storage medium, such as random access memory (RAM), read only memory (ROM), erasable programmable read only memory (EPROM), electrically erasable programmable read only memory (EEPROM), or flash memory, for example, wherein, when the computer program code is loaded into and executed by a computer, the computer becomes an apparatus for practicing an embodiment. An embodiment as disclosed herein may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing an embodiment. When implemented on a general-purpose microprocessor, the computer program code segments configure the microprocessor to create specific logic circuits. A technical effect of the executable instructions is to control one or more vehicles of a swarm fleet and/or process radar signals provided by the swarm fleet.

As used herein, where one element disclosed herein is configured and/or disposed to be in communication with and/or operational control of another element disclosed herein, such configuring may be accomplished via machine executable instructions executed via a processing circuit in a manner consistent with this disclosure as a whole.

From the foregoing, it will be appreciated that one or more embodiments of the invention may include one or more of the following features and/or advantages: improved intelligence, surveillance, and reconnaissance operations involving corresponding operational vehicles; improved collision avoidance for beyond visual line of sight situations between corresponding operational vehicles; reduced operator workload and/or more automated operational control with respect to corresponding operational vehicles; improved identification of suspect objects and/or situations from longer distances and higher elevations than may be capable with cameras only; increased surveillance coverage from further range ability than may be capable with cameras only; improved identification and updates of mobile and stationary threats, including but not limited to improvised explosive devices, concealed weapons, concealed people, etc.; improved knowledge or determination of direction and/or speed of suspected threat; improved surveillance operation during nighttime and adverse weather; longer operation or flight duration by virtue of lower power consumption and/or weight of a given vehicle; ability to avoid adverse detection via mobile base stations; potential to modularize vehicle payload capability with respect to radar, camera, weaponry, or other utility features; improved in-service time via wireless charging stations; ability to employ low cost over the counter vehicles (e.g. drones) with radar enabled surveillance to create virtual synthetic radar aperture comprised of data from multiple vehicles; a swarm fleet management system with improved surveillance area coverage, enhanced vehicle (e.g. drone) power recharging, enhanced data capture with capability of dispatching additional vehicles on demand via densification or replace management, enhanced multi-vehicle image compilation for target identification; optimized surveillance system for cost, size, weight, and power, considerations; secure air-to-ground (i.e., vehicle-to-base) communications via a linked dedicated base station; utilization of swarm/fleet management software that includes—take-off and landing control, surveillance area/flight path control, recharge/refuel management, collision avoidance, dispatch of additional drones/vehicles for enhanced radar capture, and multi-drone image compilation capability for enhanced target identification.

In an embodiment: the vehicle (e.g., drone) 200 and radar module 230 each comprise RF CMOS integrated circuitry for high resolution imagery, and are capable of providing a low power and low cost system due to the availability of consumer off the shelf base devices that are modifiable as disclosed herein; the antenna 220 is operable via a DRA having MIMO and wide aperture capability; the connectivity modules 240, 340 are capable of 802.11 60-81 GHz WiFi or cellular communications with high data rates and interference immunity; and, the base signal processing unit 360 is capable of processing radar signals utilizing compression, cybersecurity, and multi-radar imaging resolution techniques.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element is referred to herein as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. A radar-enabled multi-vehicle system, comprising:
at least two vehicles, each vehicle comprising:
at least one antenna;
a radar module configured and disposed to be in signal communication with the at least one antenna, the radar module configured to transmit and receive radar signals from and to the at least one antenna;
a connectivity module configured and disposed to be in signal communication with the radar module, and to be in signal communication with a corresponding connectivity module of another one of the at least two vehicles; and
a power source configured and disposed to provide operational power to the at least one antenna, the radar module, and the connectivity module.

2. The system of claim 1, further comprising:
a base station comprising:
a base connectivity module configured and disposed to be in signal communication with a corresponding connectivity module of each of the at least two vehicles, the base connectivity module configured and disposed for receiving communication signals from the at least two vehicles, the communication signals including information based at least in part on corresponding received radar signals; and
a base signal processing unit configured and disposed to be in signal communication with the base connectivity module, the base signal processing unit configured and disposed for executing machine executable instructions which when executed by the base signal processing unit facilitates signal processing and image reconstruction based at least in part on the received communication signals from the at least two vehicles.

3. The system of claim 2, wherein:
the signal processing and image reconstruction is based at least in part on an aggregate of radar data from received radar signals from corresponding multiple ones of the at least two vehicles, the aggregate radar data creating a virtual synthetic radar antenna aperture that is communicated to the base station from each of the at least two vehicles, the signal processing and image reconstruction providing a single consolidated image.

4. The system of claim 2, wherein:
the signal processing and image reconstruction is based at least in part on an aggregate of radar data from received radar signals from a single one of the at least two vehicles that is in motion, the aggregate radar data creating a synthetic radar antenna aperture that is communicated to the base station from the single one of the at least two vehicles that is in motion, the distance the corresponding single vehicle travels over a target in the time taken for the radar pulses to return to the corresponding at least one antenna creates the synthetic radar antenna aperture, the signal processing and image reconstruction providing a single consolidated image.

5. The system of claim 2, wherein:
the at least two vehicles are operational and movable with respect to a first reference coordinate system; and
the base station is operational and stationary with respect to the first reference coordinate system.

6. The system of claim 2, wherein:
the at least two vehicles are operational and movable with respect to a first reference coordinate system; and
the base station is operational and movable with respect to the first reference coordinate system.

7. The system of claim 1, wherein the at least one antenna is configured as a transmitter antenna, a receiver antenna, or both a transmitter and a receiver antenna.

8. The system of claim 2, wherein:
the at least one antenna is configured as a transmitter antenna, a receiver antenna, or both a transmitter and a receiver antenna; and
the base connectivity module is configured to receive signal communications from a corresponding connectivity module of each of the at least two vehicles, to transmit signal communications to a corresponding connectivity module of each of the at least two vehicles, or to both receive and transmit signal communications from and to a corresponding connectivity module of each of the at least two vehicles.

9. The system of claim 8, wherein the base station further comprises:
a base fleet management processing unit configured and disposed in signal communication with the base connectivity module, the base fleet management processing unit configured and disposed for executing machine executable instructions which when executed by the base fleet management processing unit facilitates coordinated operational control of each of the at least two vehicles via the base connectivity module and corresponding connectivity modules of the at least two vehicles.

10. The system of claim 9, wherein:
the coordinated operational control of each of the at least two vehicles includes vehicle collision avoidance control between any of the at least two vehicles.

11. The system of claim 9, wherein:
the coordinated operational control of each of the at least two vehicles includes beyond visual line of sight control with respect to each of the at least two vehicles.

12. The system of claim 9, wherein:
the coordinated operational control of each of the at least two vehicles includes suspect object or threat identification control with respect to each of the at least two vehicles.

13. The system of claim 9, wherein:
the coordinated operational control of each of the at least two vehicles includes surveillance area control with respect to each of the at least two vehicles.

14. The system of claim 9, wherein:
the coordinated operational control of each of the at least two vehicles includes power monitoring control with respect to each of the at least two vehicles.

15. The system of claim 9, wherein:
the coordinated operational control of each of the at least two vehicles includes coordinated movement control with respect to each of the at least two vehicles.

16. The system of claim 9, wherein:
the coordinated operational control of each of the at least two vehicles includes coordinated vehicle densification or replace control with respect to each of the at least two vehicles.

17. The system of claim 1, wherein:
each of the at least two vehicles are terrestrial vehicles.

18. The system of claim 1, wherein:
each of the at least two vehicles are automotive vehicles.

19. The system of claim 1, wherein:
each of the at least two vehicles are autonomous vehicles.

20. The system of claim 1, wherein:
each of the at least two vehicles are unmanned autonomous vehicles.

21. The system of claim 1, wherein:
each of the at least two vehicles are unmanned autonomous flying vehicles, UAFVs.

22. The system of claim 1, wherein:
the radar module is a mm-wave radar module.

23. A radar-enabled multi-vehicle system, comprising:
at least one unmanned autonomous flying vehicle, UAFV, comprising:
at least one antenna;
a radar module configured and disposed to be in signal communication with the at least one antenna, the radar module configured to transmit and receive radar signals from and to the at least one antenna;
a connectivity module configured and disposed to be in signal communication with the radar module, and to be in signal communication with a corresponding connectivity module of another one of the at least one UAFV; and
a power source configured and disposed to provide operational power to the at least one antenna, the radar module, and the connectivity module.
